(19) United States
(12) Patent Application Publication
(10) Pub. No.: US 2011/0169770 A1
(43) Pub. Date: Jul. 14, 2011

(54) ANTENNA EMBEDDED INPUT DEVICE AND ELECTRONIC DEVICE HAVING THE DEVICE

(75) Inventors: Shuichi Mishina, Miyagi-Ken (JP); Hiroyuki Takashina, Miyagi-Ken (JP); Kazunori Oshiro, Miyagi-Ken (JP); Yuichi Shimizu, Miyagi-Ken (JP)

(73) Assignee: ALPS ELECTRIC CO., LTD., Tokyo (JP)

(21) Appl. No.: 13/004,492

(22) Filed: Jan. 11, 2011

(30) Foreign Application Priority Data
Jan. 13, 2010 (JP) 2010-004595

(51) Int. Cl. G06F 3/044

(52) U.S. Cl. 345/174

(57) ABSTRACT

An antenna embedded input device includes an insulating substrate disposed along a sensing surface, measurement electrodes provided in the insulating substrate and detecting a touch of an object on the sensing surface, an antenna provided in the insulating substrate so as to surround the measurement electrodes and transmitting or receiving a balanced signal, a grounding terminal provided in the insulating substrate, and a grounding conductor connecting an electric midpoint of the antenna to the grounding terminal.

### CROSS REFERENCE TO RELATED APPLICATION

The present invention contains subject matter related to and claims the benefit of Japanese Patent Application No. JP 2010-004595 filed in the Japanese Patent Office on Jan. 13, 2010, the entire contents of which is incorporated herein by reference.

### BACKGROUND OF THE DISCLOSURE

1. Technical Field

The present invention relates to an antenna embedded input device, and an electronic device having the same.

2. Related Art

As a touch type input device, for example, a touch pad input device is mounted on an electronic device such as a laptop type personal computer (laptop computer). In the laptop computer, a main body having a keyboard and a display are joined to each other via a hinge, and the touch pad input device is disposed in front of the keyboard in the main body.

In the laptop computer, a shield member is provided inside a housing of the main body. The shield member is provided so as to cover electronic devices positioned inside the main body, and suppresses unnecessary electromagnetic waves from being radiated or incident (EMI countermeasure: Electro-Magnetic Interference).

At this time, an opening portion for disposing the touch pad input device is provided in the housing and the shield member of the main body, and a face sheet of the touch pad input device is exposed from the opening portion and forms a sensing surface.

The touch pad input device has measurement electrodes and detection circuits which are used to detect an object approaching the sensing surface. The measurement electrodes include, for example, a plurality of X electrodes extending along the sensing surface, a plurality of Y electrodes extending in a direction perpendicular to the X electrodes, and detection electrodes arranged to be engaged with the Y electrodes. In this case, the approach of an object to the sensing surface is detected by detecting variation in the capacitance between the X electrodes or the Y electrodes and the detection electrodes.

U.S. Pat. No. 6,380,930 proposes a touch pad module with an antenna in which an antenna is added to this kind of touch pad input device. The touch pad module is regarded as being capable of communicating with the outside world via an antenna which is disposed in an opening portion of a shield member.

In the touch pad module disclosed in U.S. Pat. No. 6,380,930, the antenna is provided in, for example, a printed Circuit board of the touch pad. Also, the antenna may be disposed between layers which are usable due to the touch pad array itself or in individual flexible substrates adjacent to the layers.

### SUMMARY OF THE DISCLOSURE

There is an input device having a frame ground as an ESD (Electrostatic Discharge) countermeasure. The frame ground prevents destruction of electric circuits of the input device when surge currents resulting from static electricity flow into the input device and prevents large currents from flowing to the outside from the input device at the time of abnormality.

Specifically, a substantially ring-shaped ground pattern constituting the frame ground is provided in a sensing surface side of an insulating substrate of the input device, so as to surround the measurement electrodes. The frame ground is electrically connected to a frame ground of an electronic device equipped with the input device via a grounding electrode provided in the insulating substrate.

In a case where an antenna is formed on the outside of the ground pattern, the size of the insulating substrate increases, and the size of the input device increases accordingly. Also, if the ground pattern having a large width exists around the antenna, electromagnetic waves or magnetic flux generated from the antenna are reflected from or absorbed by the ground pattern, and this deteriorates communication performance.

An advantage of aspects of the invention is to provide an antenna embedded input device, which is prevented from increasing in size, has an excellent resistance to static electricity, and has a good communication performance, and an electronic device having the device.

It is possible to provide an antenna that can additionally be given to the ground pattern. However, when the ground pattern is used as an antenna, there is a problem in that surge currents resulting from static electricity cause destruction of electric circuits of the antenna. Also, naturally, the antenna is designed such that its inductance or quality coefficient (Q value) becomes a predetermined value, but the ground pattern is designed so as to be thick and short, and thus the antenna and the ground pattern are different in terms of the design concept.

According to an aspect of the embodiments of the present disclosure, there is provided an antenna embedded input device including an insulating substrate disposed along a sensing surface; measurement electrodes provided in the insulating substrate and detecting a touch of an object on the sensing surface; an antenna provided in the insulating substrate so as to surround the measurement electrodes and transmitting or receiving a balanced signal; a grounding terminal provided in the insulating substrate; and a grounding conductor connecting an electric midpoint of the antenna to the grounding terminal.

The antenna is provided to surround the measurement electrodes, and the electric midpoint of the antenna is connected to the grounding terminal. Thus, the antenna can be grounded, and thus the antenna functions as a frame ground. Therefore, in an electronic device equipped with the antenna embedded input device, when surge currents resulting from a discharge of static electricity or the like flow into the antenna, the surge currents are retained in the grounding terminal. Thereby, electric circuits connected to the antenna are protected from destruction caused by the surge currents.

A potential at the electric midpoint of the antenna is always 0V when a balanced high frequency signal is transmitted and received via the antenna. For this reason, when a balanced high frequency signal is input and output using the antenna, the grounded electric midpoint of the antenna has little effects on the transmission and reception functions of the antenna.

As a result, the antenna embedded input device is prevented from increasing in size, has an excellent resistance to static electricity, and has a good communication performance.

Also, the antenna may include a first antenna pattern, and the first antenna pattern may be disposed on a first surface of the insulating substrate positioned at the sensing surface side so as to surround the measurement electrodes.

In these embodiments, since the first antenna pattern is provided in the first surface of the insulating substrate in the sensing surface side, when surge currents resulting from static electricity flow into the input device, the surge currents flow into the first antenna pattern. For this reason, the surge currents are prevented from flowing into the measurement electrodes and thus the electric circuits connected to the measurement electrodes are protected from the destruction resulting from the surge currents.

The antenna has the first antenna pattern in the vicinity of the sensing surface and thus there are few objects which hinder communication due to the antenna. Thereby, the antenna embedded input device has an excellent communication performance.

In various embodiments, the grounding terminal is disposed on a second surface of the insulating substrate positioned at an opposite side to the sensing surface, and the antenna includes a second antenna pattern which is disposed on the second surface of the insulating substrate and has an electric midpoint.

According to these embodiments, the grounding terminal is provided in the second surface of the insulating substrate opposite to the sensing surface, and the grounding terminal is connected to an earth of an electronic device equipped with the antenna embedded input device via the shortest distance. Thereby, the antenna is connected to the earth of the electronic device via the shortest distance and surge currents are reliably retained in the earth. Therefore, the antenna embedded input device further excels in terms of resistance to static electricity.

The measurement electrodes include an electrode pattern which is disposed on the first surface of the insulating substrate so as to detect a touch of an object based on variation in the capacitance, and the second antenna pattern has a length corresponding to the length of the first antenna pattern and is electrically connected in series to the first antenna pattern.

Since the first antenna pattern surrounds the first electrode pattern, a substantial impedance for the first antenna pattern is reduced. Also, the second antenna pattern has a length corresponding to the length of the first antenna pattern. Thereby, the electric midpoint of the antenna is reliably positioned on the second antenna pattern, and the electric midpoint and the grounding terminal are connected to each other via the shortest distance.

Therefore, surge currents which flow into the antenna are reliably retained in the earth of the electronic device equipped with the antenna embedded input device.

Also, the first electrode pattern is one of the measurement electrodes, and an increase in the size of the input device due to the installation of the first electrode pattern does not occur.

Further still, a cross-sectional area of the first antenna pattern is different from the cross-sectional area of the second antenna pattern.

The cross-sectional areas of the first antenna pattern and the second antenna pattern are different from each other, and thus the impedances for the first antenna pattern and the second antenna pattern are adjusted. By the adjustment of the impedances, the electric midpoint can be reliably and easily positioned on the second antenna pattern.

The first antenna pattern includes a first part and a second part which are separated from each other, and the first part, at least a portion of the second antenna pattern, and the second part are electrically connected in series in this order.

Since the first antenna pattern is constituted by the first part and the second part, and at least a portion of the second antenna pattern is inserted into the first antenna pattern, the electric midpoint can be reliably and easily positioned on the second antenna pattern.

The antenna may also include a third antenna pattern. The third antenna pattern is disposed in parallel to the first surface inside the insulating substrate. The first antenna pattern, at least a portion of the second antenna pattern, and the third antenna pattern are electrically connected in series in this order.

By inserting the second antenna pattern between the first antenna pattern and the third antenna pattern, the electric midpoint can be reliably and easily positioned on the second antenna pattern.

In various embodiments, the antenna is connected to the grounding terminal via a varistor.

In such embodiments, when surge currents flow into the antenna, the surge currents are more reliably retained in the grounding terminal.

A detection circuit which detects a touch of an object on the sensing surface in cooperation with the measurement electrodes is provided in the insulating substrate, and a signal ground of the detection circuit is electrically connected to the grounding terminal.

With such a detection circuit, the number of grounding terminals provided in the insulating substrate is suppressed.

Also, a detection circuit which detects a touch of an object on the sensing surface in cooperation with the measurement electrodes is provided in the insulating substrate, and a signal ground of the detection circuit is electrically floated with respect to the grounding terminal.

With such a detection circuit, surge currents are prevented from flowing into the detection circuit via the grounding terminal.

The antenna embedded input device further includes a mesh-shaped shield electrode which is provided farther away than the measurement electrodes when seen from the sensing surface in the insulating substrate.

The accuracy of object detection is heightened by the shield electrodes. In addition, since the shield electrodes has the mesh shape, the reflection or the absorption of electromagnetic waves or magnetic flux generated by the antenna is suppressed by the shield electrodes.

As a result, the antenna embedded input device has an excellent accuracy of object detection, an excellent resistance to static electricity, and a good communication performance.

According to various embodiments of the present disclosure, there is provided an electronic device including the above-described antenna embedded input device.

In such electronic devices, instructions are always smoothly input to the electronic device since the antenna embedded input device has a good resistance to static electricity, and stable operations of the antenna embedded input device are secured. Further, since the antenna embedded input device has a good communication performance, the electronic device is operated according to a user's intention.

According to the various embodiments of the present disclosure, it is possible to provide an antenna embedded input device, which is prevented from increasing in size, has an excellent resistance to static electricity, and has a good communication performance, and an electronic device having the device.

### BRIEF DESCRIPTION OF THE DRAWINGS

FIG. 1 is a perspective view illustrating an exterior of a personal computer equipped with an antenna embedded input device according to an embodiment of the disclosure.

FIG. 2 is a schematic partial sectional view taken along the line II-II in FIG. 1.

FIG. 3 is a perspective view illustrating a schematic exterior of the antenna embedded input device according to an embodiment of the disclosure.

FIG. 4 is a schematic exploded perspective view of the antenna embedded input device in FIG. 3.

FIG. 5 is a schematic plan view of an X electrode layer in FIG. 4.

FIG. 6 is a schematic plan view of a printed circuit board in FIG. 4.

FIG. 7 is a block diagram illustrating a schematic electric circuit for an antenna of the antenna embedded input device in FIG. 3.

FIG. 8 is a block diagram illustrating the block diagram in FIG. 7 along with a detailed matching circuit.

FIG. 9 is a schematic plan view of an X electrode layer used for an antenna embedded input device according to an embodiment of the disclosure.

FIG. 10 is a schematic plan view of a printed circuit board used for the antenna embedded input device according to an embodiment of the disclosure.

FIG. 11 is a schematic plan view of an X electrode layer used for an antenna embedded input device according to an embodiment of the disclosure.

FIG. 12 is a schematic plan view of a printed circuit board used for the antenna embedded input device according to an embodiment of the disclosure.

FIG. 13 is a schematic plan view of a Y electrode layer used for the antenna embedded input device according to an embodiment of the disclosure.

FIG. 14 is a block diagram illustrating a schematic electric circuit for an antenna of an antenna embedded input device according to an embodiment of the disclosure.

FIG. 15 is a block diagram illustrating a schematic electric circuit for an antenna of an antenna embedded input device according to an embodiment of the disclosure.

FIG. 16 is a block diagram illustrating the block diagram in FIG. 15 along with a detailed matching circuit.

FIG. 17 is a block diagram illustrating the block diagram in FIG. 15 along with a detailed matching circuit.

### DETAILED DESCRIPTION OF THE DISCLOSURE

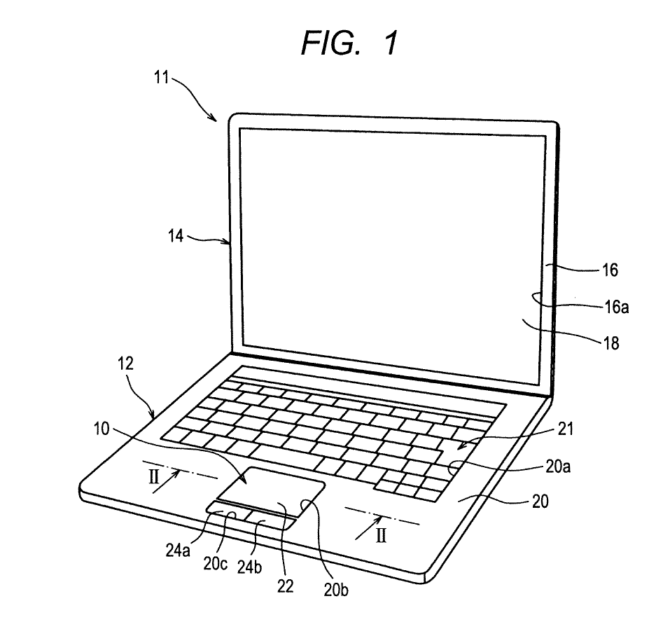

Embodiments of the present invention will now be described with reference to the accompanying drawings. The following description is intended to convey a thorough understanding of the embodiments described by providing a number of specific embodiments and details involving an antenna embedded input device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. FIG. 1 shows a laptop type personal computer (electronic device) 11 equipped with an antenna embedded input device 10 according to an exemplary embodiment. The computer 11 may have a main body 12 and a display 14, and the main body 12 and the display 14 may be joined to each other via a hinge. The display 14 may be reversibly erected with respect to the main body 12 (opened state) from an overlapping state (closed state) with the main body 12 which may lie in a parallel state, by being rotated with respect to the hinge.

The display 14 may include a display housing 16 made of, for example, resin. The display housing 16 may have a flat box shape and has substantially the same size as, for example, a sheet of A4 paper. The display housing 16 may include a surface (inner surface) opposite to the main body 12 in the closed state, and the inner surface of the display housing 16 may have an opening which may be formed in the nearly entire inner surface. The opening 16a of the display housing 16 may expose, for example, a liquid crystal panel 18.

The main body 12 may include a flat box-shaped main housing 20 made of resin.

In an upper surface of the main housing 20 opposite to the display 14 in the closed state, an opening 20a may be provided to the inside when viewing the liquid crystal panel 18, that is, on the hinge side, and a keyboard 21 may be disposed in the opening 20a. Also, the size of the upper surface of the main housing 20 may be substantially the same as that of the inner surface of the display housing 16.

An opening 20b also may be disposed at the center in front of the keyboard 21 in the upper surface of the main housing 20. The opening 20b exposes a face sheet 22 of the antenna embedded input device 10.

Also, in the upper surface of the main housing 20, an opening 20c may be disposed in front of the opening 20b, and the opening 20c may expose two buttons 24a and 24b in the width direction of the main housing 20.

Both regions of the openings 20b and 20c in the upper surface of the main housing 20 may function as a palm rest.

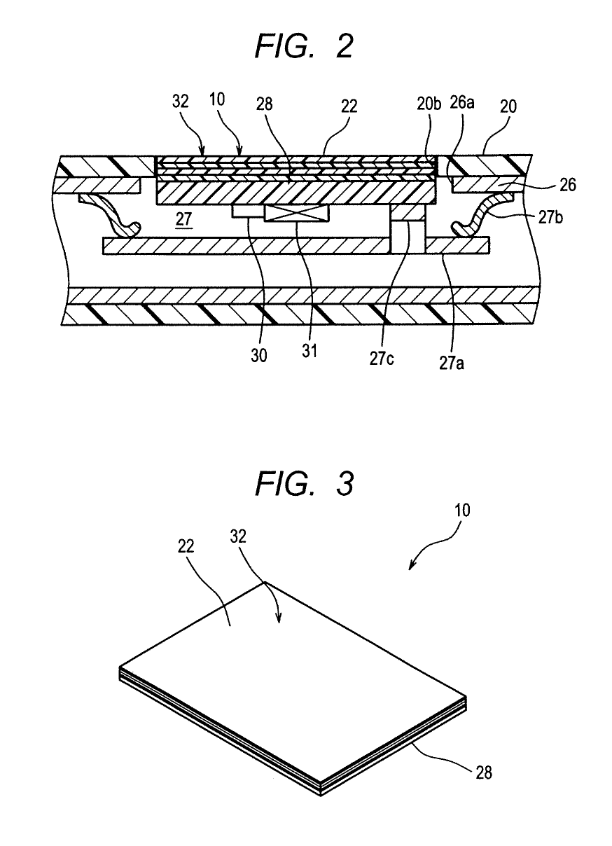

FIG. 2 is a sectional view taken along the line II-II in FIG. 1, and shows a partial cross-section of the main body 12.

A shield member 26 made of metal, for example, may be provided inside the main housing 20. The shield member 26 may have a shape slightly smaller than the main housing 20, and substantially the entire region thereof is covered by the main housing 20 except for the region where the keyboard 21, the face sheet 22, and the buttons 24a and 24b may be exposed.

An opening 26a may be provided in an upper wall of the shield member 26, corresponding to the position of the opening 20b of the main housing 20. A bottom plate 27a which may correspond to the opening 26a and is slightly larger than the opening 26a may be disposed inside the shield member 26. The bottom plate 27a may have conductivity, and the bottom plate 27a and the upper wall of the shield member 26 may be mechanically and electrically connected to each other via, for example, a plurality of connection members 27b having conductivity.

The bottom plate 27a may be disposed to block the opening 26a of the shield member 26, but the bottom plate 27a may be spaced apart from the upper wall of the shield member 26. For this reason, the bottom plate 27a and the connection members 27b may form a depression 27 extending from the opening 26a, and the antenna embedded input device 10 may be disposed in the depression 27.

A connection lead 27c may be integrally formed in the bottom plate 27a, and the connection lead 27c may be electrically connected to the antenna embedded input device 10. The connection lead 27c may be electrically connected to an earth of the personal computer 11.

### Antenna Embedded Input Device

The antenna embedded input device 10 may be a touch pad antenna embedded input device. The antenna embedded input device 10 may include a printed circuit board 28 having wires of suitable pattern (not shown), and the printed circuit board 28 may be fixed by supporting members (not shown) in the depression 27.

The printed circuit board 28 may be disposed substantially in parallel to the upper surface of the main housing 20. Electric elements such as an IC chip 30 and a connector terminal 31 may be installed on a rear surface of the printed circuit board 28 facing a bottom surface of the depression 27, that is, the bottom plate 27a. The electric elements installed on the printed circuit board 28 may be connected to a mother substrate (not shown) of the computer 11 disposed inside the shield member 26, via the connector terminal 31 and, for example, a flat cable connected to the connector terminal 31.

A laminated body 32 including the face sheet 22 may be fixed to a front surface of the printed circuit board 28 positioned at the opening 20b side. An upper surface of the face sheet 22 may be formed as a sensing surface, and a user inputs a desired instruction to the personal computer 11 via the antenna embedded input device 10 through the touch or approach of a finger tip or an object for input on the sensing surface.

FIG. 3 is a perspective view illustrating a schematic exterior of the antenna embedded input device 10. The printed circuit board 28 may have the same rectangle shape as the laminated body 32, and the laminated body 32 may be fixed to one surface of the printed circuit board 28.

### Laminated Body

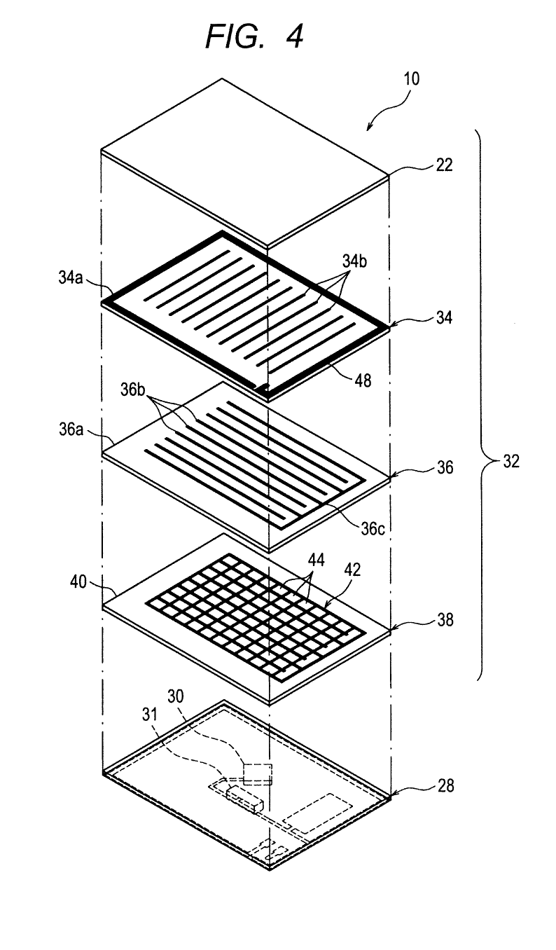

FIG. 4 is a schematic perspective view illustrating the exploded antenna embedded input device 10.

The laminated body 32 sequentially may include, from the face sheet 22 side, an X electrode layer 34, a Y electrode layer 36, and a shield electrode layer 38. The face sheet 22, the X electrode layer 34, the Y electrode layer 36, and the shield electrode layer 38 may be tightly attached to each other by a hot pressing or an adhesive.

The X electrode layer 34 may include a film substrate (X electrode substrate) 34a, and a plurality of X electrodes 34b which may be integrally formed on the film substrate 34a. The X electrodes 34b may be arranged over most of regions on one side of the film substrate 34a.

Specifically, the film substrate 34a may have a rectangle shape, and the short side of the film substrate 34a may extend in a length direction of the main body 12 of the personal computer 11, and a long side of the film substrate 34a may extend in the width direction of the main body 12 of the personal computer 11.

The X electrodes 34b may be constituted by a plurality of conductive stripes parallel to each other, and the conductive stripes respectively may extend in the short side direction of the film substrate 34a and may be spaced apart from each other at a constant interval in the long side direction of the film substrate 34a.

The Y electrode layer 36 may include a film substrate (Y electrode substrate) 36a and a plurality of Y electrodes 36b which may be integrally formed on the film substrate 36a. Also, the Y electrode layer 36 may include comb-shaped detection electrodes 36c which may be integrally formed on the film substrate 36a. The Y electrodes 36b and the detection electrodes 36c may be disposed to be engaged with each other and arranged most of the regions on one side of the film substrate 36a.

Specifically, the film substrate 36a may have the same rectangle shape as the film substrate 34a. The Y electrodes 36b may be constituted by a plurality of conductive stripes parallel to each other, and the conductive stripes may extend in the long side direction of the film substrate 36a and may be spaced apart from each other at a constant interval in the short side direction of the film substrate 36a.

The detection electrodes 36c may be constituted by a plurality of conductive stripes parallel to each other and a conductive stripe which may connect one group of ends of the stripes to each other. The plural conductive stripes of the detection electrodes 36c, in the same manner as the plural conductive stripes of the Y electrodes 36b, respectively may extend in the long side of the film substrate 36a and may be spaced apart from each other at a constant interval in the short side direction of the film substrate 36a. The plural conductive stripes of the detection electrodes 36c may be alternately disposed between the plural conductive stripes of the Y electrodes 36b.

Therefore, the Y electrodes 36b and the X electrodes 34b may be perpendicular to each other in a grid when seen from the laminated direction. Each of the detection electrodes 36c, the Y electrodes 36b, and the X electrodes 34b may constitute measurement electrodes for detecting a position of an object such as a finger tip which approaches or touches the surface of the face sheet 22.

The shield electrode layer 38 may include a film substrate (shield electrode substrate) 40 and shield electrodes 42 which are integrally formed on the film substrate 40.

The shield electrodes 42 may have layered main body portions 44 made of a conductive material, and, the main body portions 44 may be provided with a plurality of opening portions 46. The main body portions 44 may be placed at projection positions where the X electrodes 34b, the Y electrodes 36b, and the detection electrodes 36c are projected in the laminated direction of the X electrode layer 34, the Y electrode layer 36, and the shield electrode layer 38. The opening portions 46 may be placed at non-projection positions where the X electrodes 34b, the Y electrodes 36b, and the detection electrodes 36c are not projected in the laminated direction. Thus, the main body portions 44 of the shield electrodes 42 may have a grid shape in such a manner that the X electrodes 34b, the Y electrodes 36b, and the detection electrodes 36c may be combined.

The shape of the shield electrodes 42 of the shield electrode layer 38 is not limited to grid but may be a solid or the like.

Also, the film substrates 34a, 36a and 40 and the face sheet 22 may have substantially the same shape and overlap with each other by arranging four corners in order. The film substrates 34a, 36a and 40 and the printed circuit board 28 may be integrally bonded to each other and may constitute one insulating substrate having a multiple-layer structure. The face sheet 22 may protect the film substrate 34a which may be positioned at the uppermost part of the insulating substrate, and may be formed integrally with the insulating substrate or separately therefrom.

### Antenna

The antenna embedded input device 10 may have an antenna used to communicate with the outside. The antenna may be a magnetically coupled helical antenna (loop antenna).

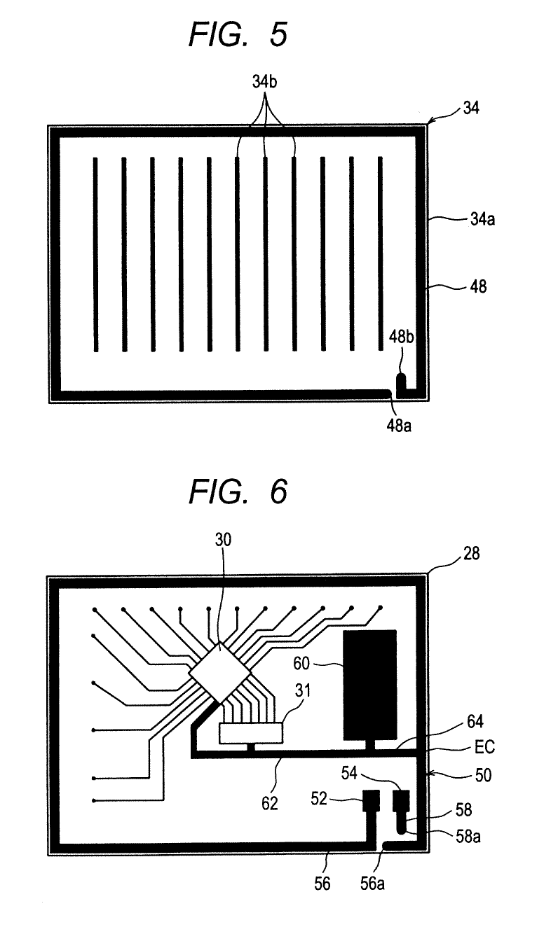

The antenna may include, as shown in FIG. 5, a first antenna pattern (X electrode layer antenna pattern) 48 which maybe integrally formed on the X electrode substrate 34a. The X electrode layer antenna pattern 48 may be constituted by a conductive stripe and is provided in outer edges of the X electrode substrate 34a so as to surround the X electrodes 34b. The X electrode layer antenna pattern 48 may extend along the outer edges of the X electrode substrate 34a, substantially over one turn. End portions 48a and 48b of the X electrode layer antenna pattern 48 may be positioned in the vicinity of each other and respectively positioned at a corner of the X electrode substrate 34a.

The antenna may include, as shown in FIG. 6, a second antenna pattern (circuit board antenna pattern) 50 which may be integrally formed on the rear surface of the printed circuit board 28 which may be positioned at the opposite side to the laminated body 32.

Also, in FIG. 6, for better understanding of a positional relationship between the circuit board antenna pattern 50 and the X electrode layer antenna pattern 48, the left and right parts are shown reversed.

The circuit board antenna pattern 50 may include a first terminal portion 52 and a second terminal portion 54 which may be spaced apart from each other in one corner of the printed circuit board 28. In addition, the circuit board antenna pattern 50 may include a loop portion 56 integrally extending from the first terminal portion 52 and a linear connection portion 58 extending from the second terminal portion 54.

The first terminal portion 52 and the second terminal portion 54 may constitute both ends of the antenna and may be formed as a land portion in this embodiment.

The loop portion 56 may be constituted by a conductive strip and may extend along the outer edges of the printed circuit board 28 substantially over one turn. Therefore, the loop portion 56 may extend substantially in the same manner as the X electrode layer antenna pattern 48 when seen from the laminated direction. Here, a position of an end portion 56a of the loop portion 56 opposite to the first terminal portion 52 may correspond to a position of the end portion 48a of the X electrode layer antenna pattern 48. The end portion 56a of the loop portion 56 and the end portion 48a maybe electrically connected to each other via a through-hole which penetrates the film substrates 34a, 36a and 40 and the printed circuit board 28 in the thickness direction.

The connection portion 58 of the circuit board antenna pattern 50 may extend in a straight manner, for example, from the second terminal portion 54. The position of the end portion 58a of the connection portion 58 opposite to the second terminal portion 54 may correspond to the position of the end portion 48b of the X electrode layer antenna pattern 48. The end portion 58a of the connection portion 58 and the end portion 48b are electrically connected to each other via a through-hole which penetrates the film substrates 34a, 36a and 40 and the printed circuit board 28 in the thickness direction.

In this way, the X electrode layer antenna pattern 48 and the circuit board antenna pattern 50 may constitute a loop antenna which has two turns.

Materials of the X electrodes 34b, the Y electrodes 36b, the detection electrodes 36c, and the antenna may use a metal such as aluminum or copper, and further may use a conductive oxide such as ITO (indium tin oxide).

As shown in FIG. 6, the IC chip 30 and the connector terminal 31 maybe installed in the center of the rear surface of the printed circuit board 28. The IC chip 30 is electrically connected to the X electrodes 34b, the Y electrodes 36b, and the detection electrodes 36c, and the IC chip 30 may include a detection circuit which may be used to detect a touch of an object on the sensing surface in cooperation with the X electrodes 34b, the Y electrodes 36b, and the detection electrodes 36c.

A grounding terminal 60 which has, for example, a rectangle shape and is made of a conductor may be integrally formed on the rear surface of the printed circuit board 28. The connection lead 27c may come into contact with the grounding terminal 60, and the grounding terminal 60 maybe electrically connected to the earth of the personal computer 11 via the connection lead 27c.

The grounding terminal 60 may be electrically connected to a predetermined terminal of the IC chip 30 and the connector terminal 31 via a lead portion 62 integrally extending therefrom. In this embodiment, a signal ground of the detection circuit of the IC chip 30 may be electrically connected to the grounding terminal 60.

The lead portion 62 and the circuit board antenna pattern 50 may be connected to each other via a bridge portion 64. Therefore, the grounding terminal 60 may be electrically connected to the circuit board antenna pattern 50 via a portion of the lead portion 62 and the bridge portion 64. In other words, a portion of the lead portion 62 and the bridge portion 64 may constitute a grounding conductor connecting the grounding terminal 60 to the antenna.

Here, the circuit board antenna pattern 50 to which the bridge portion 64 is connected may be positioned at the electric midpoint EC of the antenna. That is to say, the impedance for the antenna part from the first terminal portion 52 to the electric midpoint EC may be the same as the impedance for the antenna part from the second terminal portion 54 to the electric midpoint EC.

### Electric Circuit

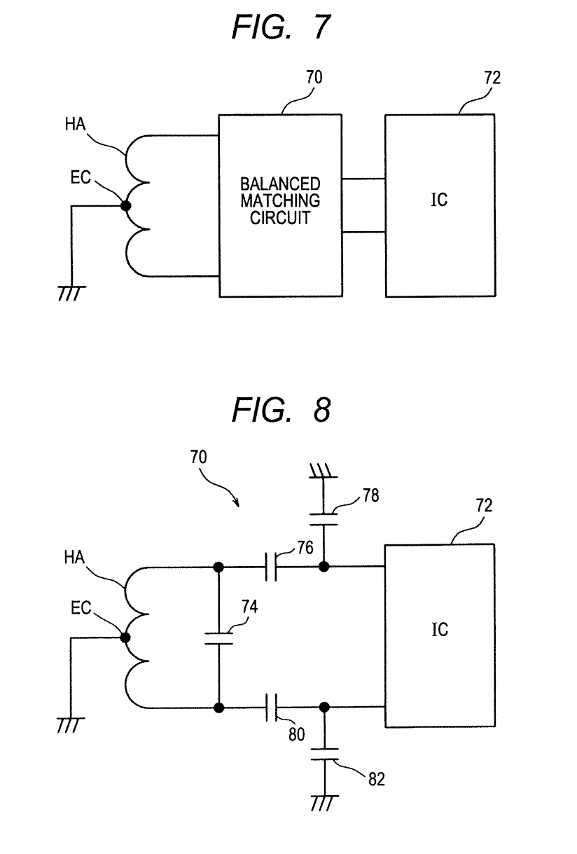

FIG. 7 is a block diagram schematically illustrating an electric circuit for the antenna. The reference numeral “HA” in the figure denotes the antenna.

The antenna HA may be used to transmit and receive a balanced high frequency signal. Thereby, both ends of the antenna HA may be connected to a matching circuit (balanced matching circuit) 70, and the matching circuit 70 may be connected to an IC chip 72. The IC chip 72 may include transmission and reception circuits. The electric midpoint EC of the antenna HA may be grounded via the grounding terminal 60.

In addition, the matching circuit 70 and the IC chip 72 maybe formed on the printed circuit board 28, or may be formed in the personal computer 11 separately from the printed circuit board 28.

FIG. 8 shows a detailed example of the matching circuit 70.

The matching circuit 70 may have a capacitor 74 which may be connected in parallel between both ends of the antenna HA, and one end of the antenna HA and the capacitor 74 may be connected to the IC chip 72 via a capacitor 76. A middle point between the capacitor 76 and the IC chip 72 may be grounded via a capacitor 78.

In the same manner, the other end of the antenna HA and the capacitor 74 may be connected to the IC chip 72 via a capacitor 80. A middle point between the capacitor 80 and the IC chip 72 may be grounded via a capacitor 82.

According to the above-described antenna embedded input device 10 in the first embodiment, the antenna HA may be provided to surround the X electrodes 34b, the Y electrodes 36b, and the detection electrodes 36c, which are measurement electrodes, and the electric midpoint EC of the antenna HA may be connected to the grounding terminal 60. Therefore, the antenna HA can be grounded and thus the antenna HA functions as a frame ground.

Therefore, in the personal computer 11 equipped with the antenna embedded input device 10, when surge currents resulting from discharge of static electricity or the like flow into the antenna HA, the surge currents maybe retained in the grounding terminal 60. Thereby, the electric circuits such as the matching circuit 70 and the IC chip 72 connected to the antenna HA may be protected from destruction caused by the surge currents.

A potential at the electric midpoint EC of the antenna HA may be 0V when a balanced high frequency signal is transmitted and received via the antenna HA. For this reason, when a balanced high frequency signal is input and output using the antenna HA, the grounded electric midpoint EC of the antenna HA has little effects on the transmission and reception functions of the antenna HA.

As a result, the antenna embedded input device 10 is prevented from increasing in size, has an excellent resistance to static electricity, and has a good communication performance.

Since in the antenna embedded input device 10 according to various embodiments, the X electrode layer antenna pattern 48 may be provided on the upper surface of the X electrode substrate 34a in the face sheet 22 side, when surge currents resulting from static electricity flow into the antenna embedded input device 10, the surge currents flow into the X electrode layer antenna pattern 48. For this reason, the surge currents may be prevented from flowing into the X electrodes 34b and thus the electric circuits such as the IC chip 30 connected to the X electrodes 34b are protected from the destruction caused by the surge currents.

The antenna HA has the X electrode layer antenna pattern 48 directly under the face sheet 22 and thus there are few objects which hinder communication due to the antenna HA. Thereby, the antenna embedded input device 10 may have an excellent communication performance.

According to the above-described antenna embedded input device 10, the grounding terminal 60 may be provided on the rear surface of the printed circuit board 28 opposite to the face sheet 22, and the grounding terminal 60 may be connected to the earth of the personal computer 11 equipped with the antenna embedded input device 10 via the shortest distance. Thereby, antenna HA may be connected to the personal computer 11 via the shortest distance and surge currents are reliably retained in the earth. Therefore, the antenna embedded input device 10 further excels in the resistance to static electricity.

According to the above-described antenna embedded input device 10, since the X electrode layer antenna pattern 48 surrounds the X electrodes 34b, a substantial impedance for the X electrode layer antenna pattern 48 maybe reduced. Also, the circuit board antenna pattern 50 has a length corresponding to the length of the X electrode layer antenna pattern 48. Here, having the corresponding length means that the length of the circuit board antenna pattern 50 may be substantially the same as the length of the X electrode layer antenna pattern 48.

For this reason, the impedance for the X electrode layer antenna pattern 48 may be lower than the impedance for the circuit board antenna pattern 50. Therefore, the electric midpoint EC of the antenna HA may be reliably positioned on the circuit board antenna pattern 50 and thus the electric midpoint EC and the grounding terminal 60 may be connected to each other via the shortest distance.

Therefore, surge currents which may flow into the antenna HA may be reliably retained in the personal computer 11 equipped with the antenna embedded input device 10.

Also, the X electrodes 34b are one of the measurement electrodes, and an increase in the size of the antenna embedded input device 10 due to the installation of the X electrodes 34b does not occur.

In the above-described the antenna embedded input device 10, cross-sectional areas of the X electrode layer antenna pattern 48 and the circuit board antenna pattern 50 may be different from each other, and thus the impedances for the X electrode layer antenna pattern 48 and the circuit board antenna pattern 50 are adjusted. By the adjustment of the impedances, the electric midpoint EC can be reliably and easily positioned on the circuit board antenna pattern 50.

More specifically, the position of the electric midpoint EC can be adjusted by increasing or decreasing the width of the circuit board antenna pattern 50 as compared with a width of the X electrode layer antenna pattern 48. Thus, no matter where the grounding terminal 60 is positioned in the printed circuit board 28, the electric midpoint EC can be positioned in the vicinity of the grounding terminal 60, and thus the antenna HA may be connected to the personal computer 11 via the shortest distance.

In the above-described antenna embedded input device 10, the signal ground of the detection circuit constituted by the IC chip 30 may be connected to the grounding terminal 60, and the grounding terminal 60 also may be used as a grounding terminal for the detection circuit. For this reason, the number of grounding terminals provided in the printed circuit board 28 may be suppressed.

In the above-described antenna embedded input device 10, accuracy of object detection is heightened by the shield electrodes 42. In addition, since the shield electrodes 42 may have a mesh shape, the reflection or the absorption of electromagnetic waves or magnetic flux generated from the antenna HA may be suppressed by the shield electrodes 42.

As a result, the antenna embedded input device 10 has an excellent the accuracy of object detection, an excellent resistance to static electricity, and a good communication performance.

In the personal computer 11 embodiment, instructions may be smoothly input to the personal computer 11 since the antenna embedded input device 10 has a good resistance to static electricity, and stable operation of the antenna embedded input device 10 is secured. Further, since the antenna embedded input device 10 has a good communication performance, the personal computer 11 may be operated according to a user's intention. For example, when an RFID (Radio Frequency IDentification) card is disposed on the face sheet 22, the personal computer 11 optimally and accurately performs predetermined communication with the RFID card.

Hereinafter, a touch pad input device according to a various additional embodiments will be described. In addition, members having the same configuration or function as the antenna embedded input device 10 according to the above described embodiments are given the same reference numerals, and the description thereof will be suitably omitted.

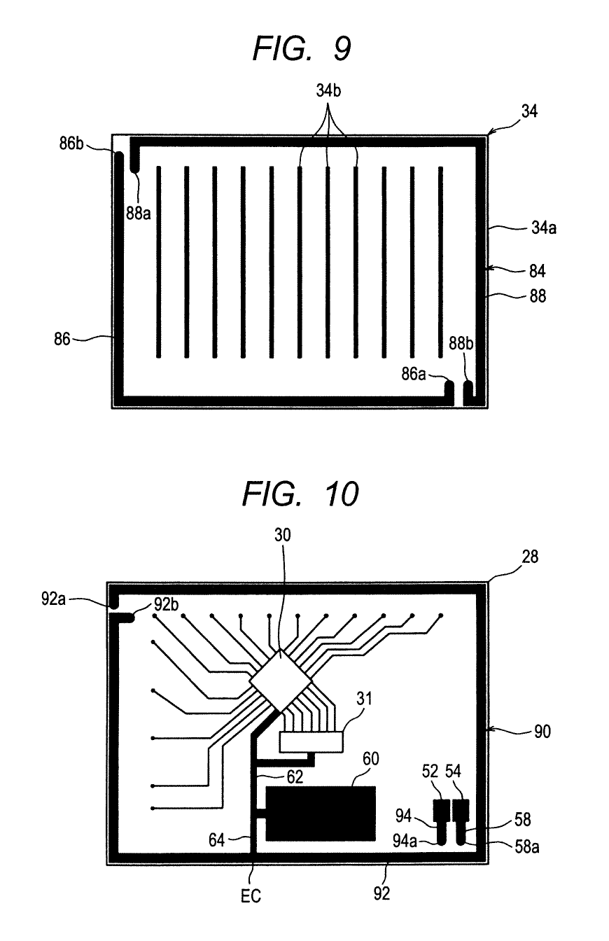

FIG. 9 shows an X electrode layer 34 used for an antenna embedded input device 10. An X electrode layer antenna pattern 84 of the X electrode layer 34 may be constituted by a first part 86 and a second part 88.

The first part 86 may extend from one corner to opposite corners of the X electrode substrate 34a along two side edges of the X electrode substrate 34a. The second part 88 may extend from one corner to the opposite corners of the X electrode substrate 34a but may extend along the other two side edges of the X electrode substrate 34a different from the first part 86. Therefore, the first part 86 and the second part 88 may surround the X electrodes 34b in cooperation.

FIG. 10 schematically shows a printed circuit board 28 used for the antenna embedded input device. In FIG. 10, the left and right parts are shown reversed, as in FIG. 6.

In a circuit board antenna pattern 90 provided in the printed circuit board 28, a loop portion 92 and a first terminal portion 52 may be separated from each other, and the first terminal portion 52 may have a linear connection portion 94 integrally extending therefrom. The loop portion 92 may have both ends 92a and 92b which are separated from each other in the diagonal direction towards the first terminal portion 52 and the second terminal portion 54.

In this embodiment, the first part 86 of the X electrode layer antenna pattern 84, the loop portion 92 of the circuit board antenna pattern 90, and the second part 88 of the X electrode layer antenna pattern 84 may be electrically connected in series in this order. For this reason, end portions 86a and 86b of the first part 86 of the X electrode layer antenna pattern 84, end portions 88a and 88b of the second part 88, end portions 92a and 92b of the loop portion 92 of the circuit board antenna pattern 90, and end portion 58a and 94a of the connection portions 58 and 94 may be set to be positioned appropriately.

Specifically, the end portion 94a of the connection portion 94 of the circuit board antenna pattern 90 may be positioned to correspond to the end portion 86a of the first part 86 of the X electrode layer antenna pattern 84, and the end portion 94a and the end portion 86a are electrically connected to each other via a through-hole.

Likewise, the end portion 86b of the first part 86 of the X electrode layer antenna pattern 84 may be positioned to correspond to the end portion 92a of the loop portion 92 of the circuit board antenna pattern 90, and the end portion 86b and the end portion 92a are electrically connected to each other via a through-hole. The end portion 92b of the loop portion 92 of the circuit board antenna pattern 90 may be positioned to correspond to the end portion 88a of the second part 88 of the X electrode layer antenna pattern 84, and the end portion 92b and the end portion 88a may be electrically connected to each other via a through-hole. The end portion 88a of the second part 88 of the X electrode layer antenna pattern 84 may be positioned to correspond to the end portion 58a of the connection portion 58 of the circuit board antenna pattern 90, and the end portions 88a and the end portion 58a may be electrically connected to each other via a through-hole.

According to the above-described antenna embedded input device, since the X electrode layer antenna pattern 84 is constituted by the first part 86 and the second part 88, and the loop portion 92 of the circuit board antenna pattern 90 may be inserted between the X electrode layer antenna pattern 84, the electric midpoint EC can be reliably and easily positioned on the circuit board antenna pattern 90.

In this embodiment, the position of the grounding terminal 60 in the printed circuit board 28 may be different from that in the above-described embodiments. In this case as well, the position of the electric midpoint EC of the antenna HA may be appropriately adjusted, and thus the electric midpoint EC and the grounding terminal 60 may be connected to each other via the shortest distance. In other words, regardless of the position of the grounding terminal 60, the electric midpoint EC of the antenna HA and the grounding terminal 60 may be connected to each other via the shortest distance.

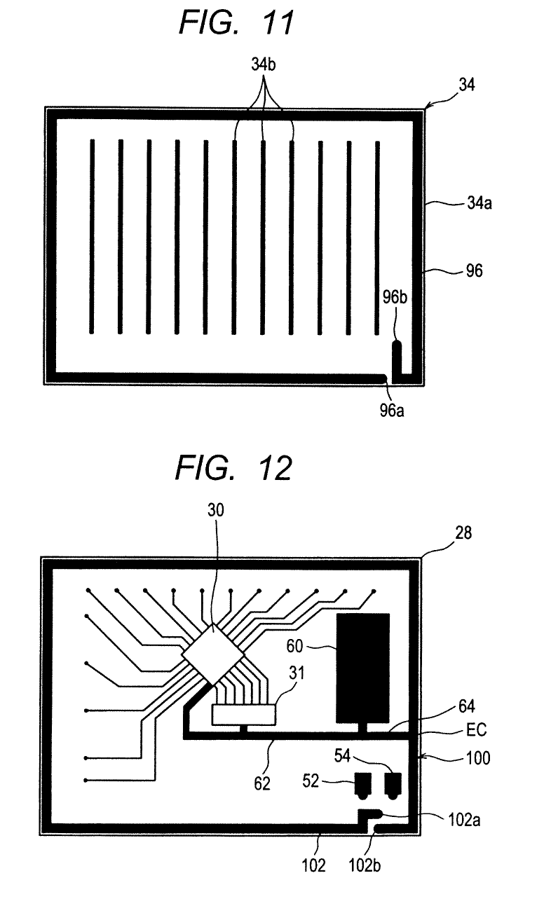

FIGS. 11, 12 and 13 schematically show an X electrode layer 34, a printed circuit board 28, and a Y electrode layer 36 used for an antenna embedded input. An X electrode layer antenna pattern 96, a circuit board antenna pattern 98, and a Y electrode layer antenna pattern 100 may be respectively provided in the X electrode layer 34, the printed circuit board 28, and the Y electrode layer 36. The X electrode layer antenna pattern 96, a loop portion 102 of the circuit board antenna pattern 98, and the Y electrode layer antenna pattern 100 may be electrically connected in series in this order.

For this reason, end portions 96a and 96b of the X electrode layer antenna pattern 96, a first terminal portion 52 and a second terminal portion 54 of the circuit board antenna pattern 98, end portions 102a and 102b of the loop portion 102, and end portions 100a and 100b of the Y electrode layer antenna pattern 100 may be set to be positioned appropriately.

Specifically, in this embodiment, the first terminal portion 52 of the circuit board antenna pattern 98 may be positioned to correspond to the end portion 100a of the Y electrode layer antenna pattern 100, and the first terminal portion 52 and the end portion 100a are electrically connected to each other via a through-hole.

Likewise, the end portion 100a of the Y electrode layer antenna pattern 100 may be positioned to correspond to the end portion 102a of the loop portion 102 of the circuit board antenna pattern 98, and the end portion 100a and the end portion 102a may be electrically connected to each other via a through-hole. The end portion 102b of the loop portion 102 of the circuit board antenna pattern 98 may be positioned to correspond to the end portion 96a of the X electrode layer antenna pattern 96, and the end portion 102b and the end portion 96a may be electrically connected to each other via a through-hole. Further, the end portion 96b of the X electrode layer antenna pattern 96 may be positioned to correspond to the second terminal portion 54 of the circuit board antenna pattern 98, and the end portion 96b and the second terminal portion 54 may be electrically connected to each other.

Therefore, in this embodiment, the antenna HA may further include the Y electrode layer antenna pattern 100, and the Y electrode layer antenna pattern 100 maybe arranged in parallel to the X electrode layer antenna pattern 96 and the circuit board antenna pattern 98 inside the laminated body 32.

According to the above-described antenna embedded input device, by inserting the loop portion 102 of the circuit board antenna pattern 98 between the X electrode layer antenna pattern 96 and the Y electrode layer antenna pattern 100, the electric midpoint EC can be reliably and easily positioned on the circuit board antenna pattern 98.

### FOURTH EMBODIMENT

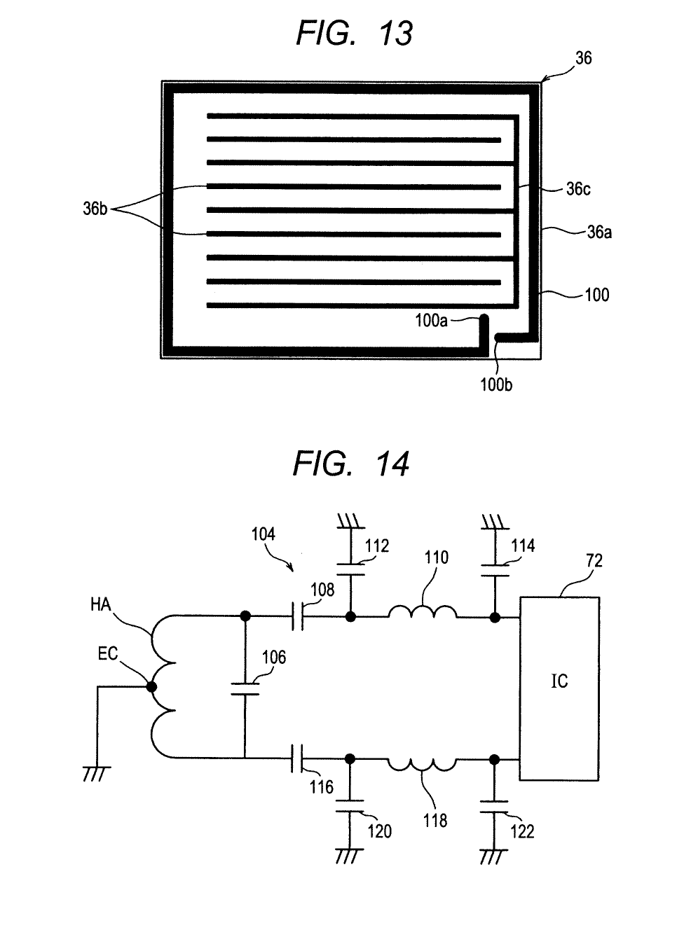

FIG. 14 schematically shows an electric circuit for the antenna HA in an antenna embedded input device according to an exemplary embodiment.

In the electric circuit shown in FIG. 14, a matching circuit 104 has a capacitor 106 connected in parallel between both ends of the antenna HA, and one end of the antenna HA and the capacitor 106 may be connected to an IC chip 72 via a capacitor 108 and an inductor 110. Both ends of the inductor 110 are grounded via capacitors 112 and 114.

Likewise, the other end of the antenna HA and the capacitor 106 maybe connected to the IC chip 72 via a capacitor 116 and an inductor 118. Both ends of the inductor 118 are grounded via capacitors 120 and 122.

That is to say, the configuration of the matching circuit for the antenna HA may not be particularly limited but may be appropriately set according to the characteristics of the antenna HA.

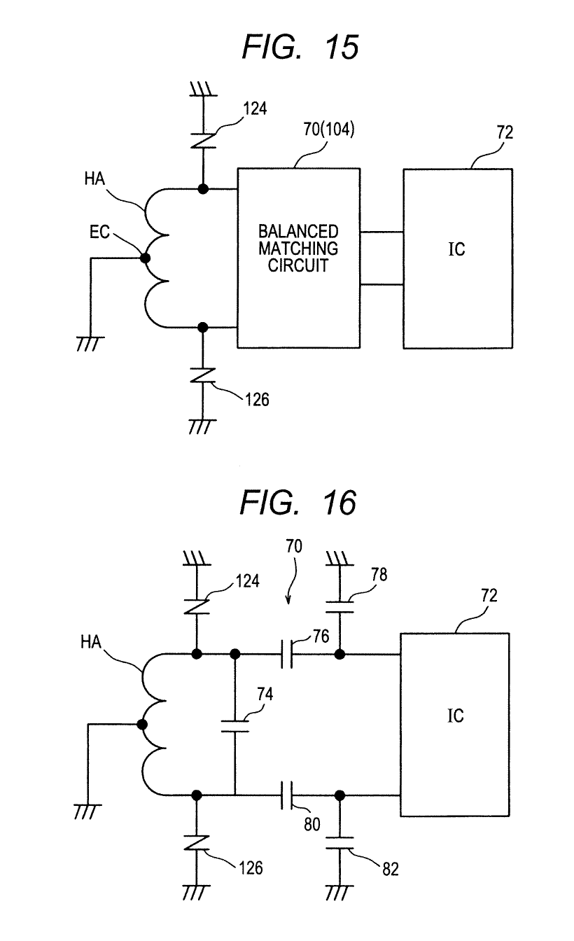

FIG. 15 schematically shows an electric circuit for the antenna HA in an antenna embedded input device. As shown in FIG. 15, the antenna HA may be connected to the grounding terminal 60 via varistors 124 and 126. The varistors 124 and 126 enable currents to be retained in the grounding terminal 60 only when a voltage exceeding a predetermined value is applied to the antenna HA.

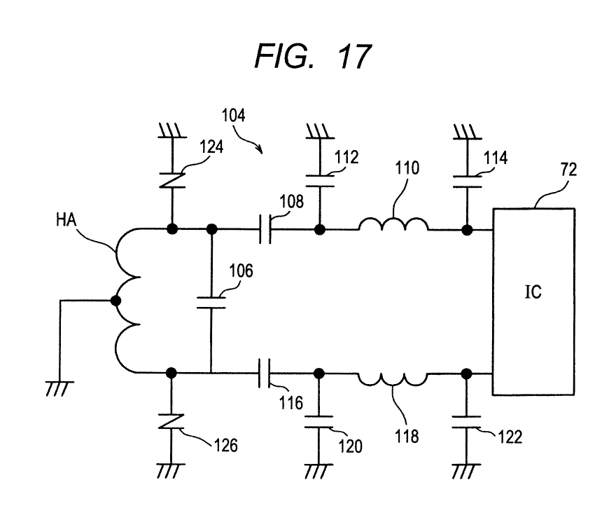

FIGS. 16 and 17 show in detail matching circuits usable along with the varistors 124 and 126, and the matching circuit 70 and the matching circuit 104 can be used.

According to the antenna embedded input device in the such an embodiment, when surge currents flow into the antenna HA, the surge currents are more reliably retained in the grounding terminal 60.

The present invention is not limited to the embodiments described above but includes various modifications of the embodiments, and also includes appropriate combinations of the embodiments.

For example, although in the above-described embodiments, the signal ground of the detection circuit for detecting an object is connected to the grounding terminal 60, the signal ground may be electrically floated with respect to the grounding terminal 60. In this case, surge currents are prevented from flowing into the detection circuit via the grounding terminal 60.

Also, although the X electrodes 34b, the Y electrodes 36b, and the shield electrodes 42 are formed on the individual film substrates 34a, 36a and 40, they may be formed on a front surface and a rear surface of one or two film substrates. Also, using a laminated printed circuit board, the X electrodes 34b, the Y electrodes 36b, and the shield electrodes 42 may be integrally formed in the laminated printed circuit board along with the antenna HA.

In other words, the configuration of members supporting the X electrodes 34b, the Y electrodes 36b, the detection electrodes 36c, and the shield electrodes 42 is not particularly limited.

When the detection electrodes 36c are omitted and the X electrodes 34b are applied with a voltage, the Y electrodes 36b may be used as a detection electrode, and, in contrast, when the Y electrodes 36b are applied with a voltage, the X electrodes 34b may be used as a detection electrode. That is to say, a configuration of the measurement electrodes is not also particularly limited. However, the measurement electrodes may be configured in a grid or a network when seen from the top, so as to detect a touch of an object by using variation in the capacitance.

Further, the shape of the main body portion 44 of the shield electrodes 42 preferably substantially correspond with the projected shape of the measurement electrodes but may be more or less different therefrom.

Further, the turns of the antenna HA are not limited to the above-described embodiments. For example, the turns of the antenna HA may be one, or may be two or more. The antenna HA may be provided over two or more layers, or it maybe divided into a plurality of parts of two or more in each layer.

Finally, although the example where the antenna embedded input device of the present disclosure is implemented by the laptop type personal computer has been described, it is also applicable to mobile electronic devices such as a PDA (personal digital assistant) or a mobile phone. Further, the antenna embedded input device of the present disclosure is applicable to a touch panel by employing transparent measurement electrodes and shield electrodes.

It should be understood by those skilled in the art that various modifications, combinations, sub-combinations and alterations may occur depending on design requirements and other factors insofar as they are within the scope of the appended claims of the equivalents thereof.

What is claimed is:

1. An antenna embedded input device, comprising:
a sensing surface;
an insulating substrate disposed along the sensing surface;
measurement electrodes provided in the insulating substrate and detecting a touch of an object on the sensing surface;
an antenna provided in the insulating substrate so as to surround the measurement electrodes and transmitting or receiving a balanced signal, the antenna having an electric midpoint;
a grounding terminal provided in the insulating substrate; and
a grounding conductor connecting the electric midpoint of the antenna to the grounding terminal.

2. The antenna embedded input device according to claim 1, wherein the antenna includes a first antenna pattern,
wherein the first antenna pattern is disposed on a first surface of the insulating substrate positioned at the sensing surface side so as to surround the measurement electrodes.

3. The antenna embedded input device according to claim 2, wherein the grounding terminal is disposed on a second surface of the insulating substrate positioned at an opposite side to the sensing surface, and
wherein the antenna includes a second antenna pattern which is disposed on the second surface of the insulating substrate and has the electric midpoint.

4. The antenna embedded input device according to claim 3, wherein the measurement electrodes include an electrode pattern which is disposed on the first surface of the insulating substrate so as to detect a touch of an object based on variation in the capacitance, and
wherein the second antenna pattern has a length corresponding to a length of the first antenna pattern and is electrically connected in series to the first antenna pattern.

5. The antenna embedded input device according to claim 3, wherein a cross-sectional area of the first antenna pattern is different from a cross-sectional area of the second antenna pattern.

6. The antenna embedded input device according to claim 3, wherein the first antenna pattern includes a first part and a second part which are separated from each other, and
wherein the first part, at least a portion of the second antenna pattern, and the second part are electrically connected in series in this order.

7. The antenna embedded input device according to claim 3, wherein the antenna includes a third antenna pattern,
wherein the third antenna pattern is disposed in parallel to the first surface inside the insulating substrate, and
wherein the first antenna pattern, at least a portion of the second antenna pattern, and the third antenna pattern are electrically connected in series in this order.

8. The antenna embedded input device according to claim 1, wherein the antenna is connected to the grounding terminal via a varistor.

9. The antenna embedded input device according to claim 1, wherein a detection circuit which detects a touch of an object on the sensing surface in cooperation with the measurement electrodes is provided in the insulating substrate, and
wherein a signal ground of the detection circuit is electrically connected to the grounding terminal.

10. The antenna embedded input device according to claim 1, wherein a detection circuit which detects a touch of an object on the sensing surface in cooperation with the measurement electrodes is provided in the insulating substrate, and
wherein a signal ground of the detection circuit is electrically floated with respect to the grounding terminal.

11. The antenna embedded input device according to claim 1 further comprising mesh-shaped shield electrodes which are provided farther away than the measurement electrodes when seen from the sensing surface in the insulating substrate.

12. An electronic device comprising the antenna embedded input device according to claim 1.
